(19) United States
(12) Patent Application Publication
(10) Pub. No.: US 2005/0195681 A1
(43) Pub. Date: Sep. 8, 2005

(54) Lightweight concrete mixer

(76) Inventor: Henry Gembala, Delray Beach, FL (US)

Correspondence Address: Robert M. Downey, Esq., Suite 300, 601 South Federal Highway, Boca Raton, FL, 33432, US

(21) Appl. No.: 11/062,148

(22) Filed: Feb. 18, 2005

Related U.S. Application Data
(60) Provisional application No. 60/545,706, filed on Feb. 18, 2004.

(51) Int. Cl. B28C 7/16

(52) U.S. Cl. 366/46

(57) ABSTRACT

An apparatus for on-site manufacturing of lightweight concrete used for insulation in roof decks and roof systems of building structures. The apparatus is supported on a transportable trailer frame and includes a mixer, one or more tanks for holding water and chemical products, such as foaming agents, and a concrete pump. The chemical agents and water are forced through a foam generating carburetor with pressurized air to produce a foam product. Concrete and the foam product are combined in the mixer, in accordance with a predetermined mixture ratio, and released into the concrete pump for forced discharge from the apparatus and application to a roof structure. An internal combustion engine drives hydraulic pumps which operate several components of the apparatus. Controls are provided for operating the several components, functions and operations of the apparatus.

### BACKGROUND OF THE INVENTION

1. Field of the Invention

The present invention is directed to an apparatus for manufacturing lightweight concrete during the installation of roof decks of a building structure.

2. Discussion of the Related Art

Lightweight concrete is used extensively in the construction of buildings, and particularly in the installation of roof decks and related roof systems. When installing a roof deck on a building structure, lightweight concrete is disbursed, in a slurry coat, to form a topping layer of insulation over underlying roofing materials. Lightweight concrete typically consists of a combination of Portland cement, one or more foaming agents, water and possibly other chemical agents. To insure proper distribution of the lightweight concrete, prior to curing, it is important to discharge the lightweight concrete mixture on the roof deck shortly after the mixing process. Presently, the process for manufacturing lightweight concrete for on-site installation involves the use of one or more compressors, a pressurized tank for holding chemicals, a separate cement mixer, a concrete pump and an elaborate series of hoses for directing water, chemicals, cement, foaming agents and other chemicals to be mixed and discharged in rapid action. Using this method, the lightweight concrete is manufactured in batches and then discharged in a slurry coat on the roof deck. After each batch is exhausted, subsequent batches are manufactured and discharged until the installation of the lightweight concrete roof insulation is complete. The presently used method of on-site manufacturing of lightweight concrete presents several problems and concerns. Specifically, pressurized hoses have been known to burst, subjecting workers to potential serious injury. Additionally, the numerous equipment and hoses needed to mix the components of the lightweight concrete mixture often become tangled, which results in possible equipment malfunctions and operational delays. A further problem with the presently used mixing process is the inability to produce uniform and consistent mixtures of lightweight concrete which meet code requirements, such as consistency in pull strengths throughout the roof deck. Because the mixing process, and particularly the rate and amount of flow of each component in the mixture relies on human judgment, it is difficult, if not impossible, to produce uniform and consistent mixtures throughout multiple batches.

Accordingly, there is an urgent need in the construction industry for a contained and portable apparatus which is specifically structured for on-site manufacturing of lightweight concrete in a safe, controlled and highly predictable process to produce a continuous on demand supply of lightweight concrete in a consistent, uniform mixture.

### SUMMARY OF THE INVENTION

The present invention is directed to an apparatus for on-site manufacturing of lightweight concrete used for insulation in roof decks and roof systems of building structures. The apparatus is supported on a transportable trailer frame and includes a mixer, one or more tanks for holding water and chemical products, such as foaming agents, and a concrete pump. The chemical agents and water are forced through a foam generating carburetor with pressurized air to produce a foam product. Concrete and the foam product are combined in the mixer, in accordance with a predetermined mixture ratio, and released into the concrete pump for forced discharge from the apparatus and application to a roof structure. An internal combustion engine drives hydraulic pumps which operate several components of the apparatus. Controls are provided for operating the several components, functions and operations of the apparatus.

### BRIEF DESCRIPTION OF THE DRAWINGS

For a fuller understanding of the nature of the present invention, reference should be made to the following detailed description taken in conjunction with the accompanying drawings in which:

FIG. 1 is a front, top perspective view of the lightweight concrete manufacturing apparatus of the present invention, shown partially open to reveal the major components thereof;

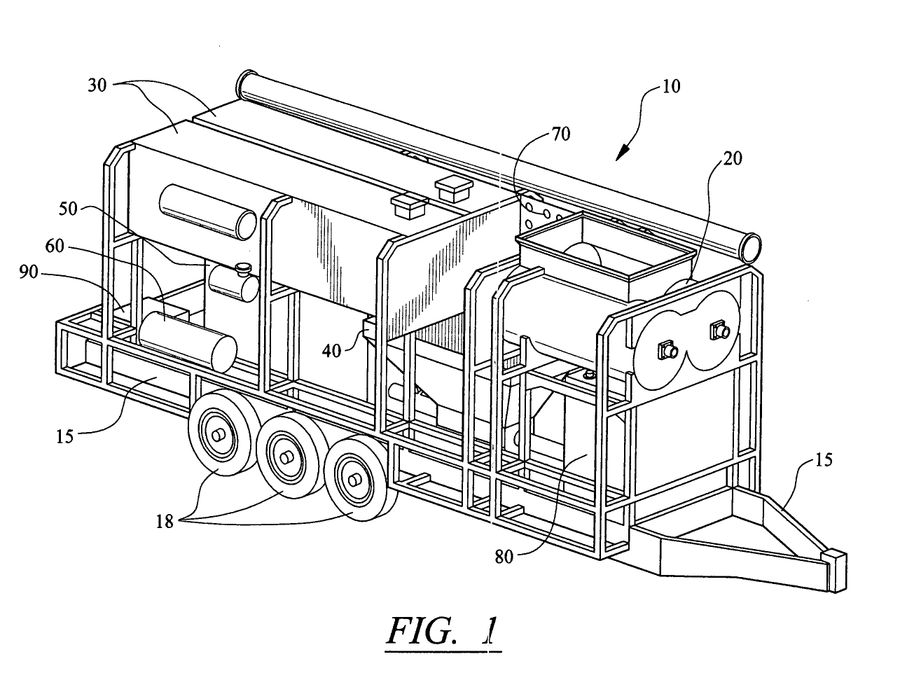

FIG. 2 is a front, top perspective view of the lightweight concrete manufacturing apparatus, shown fully assembled; and

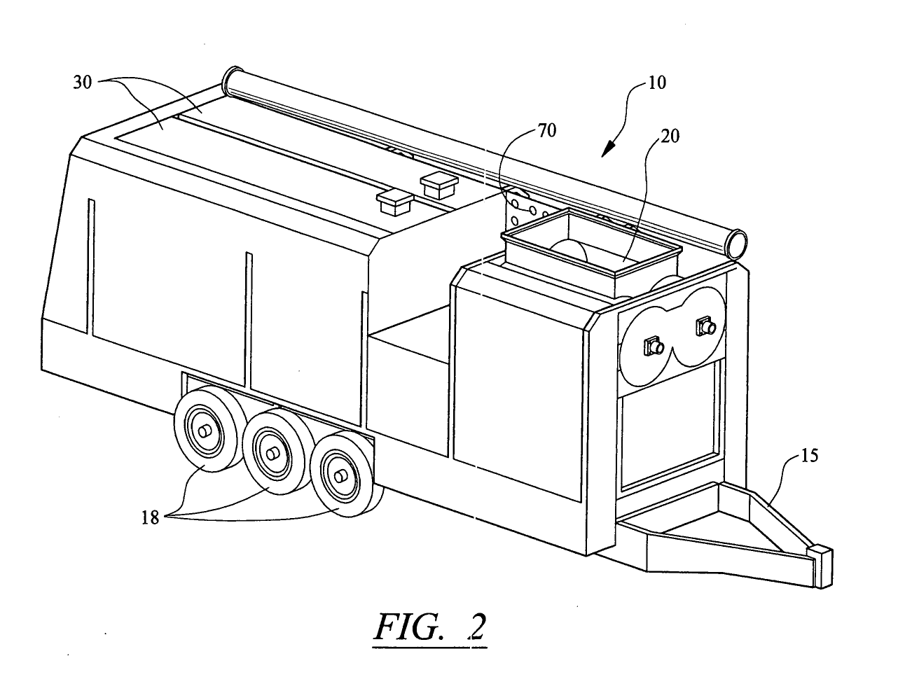

FIG. 3 is a side elevational view of the apparatus, showing the primary components thereof.

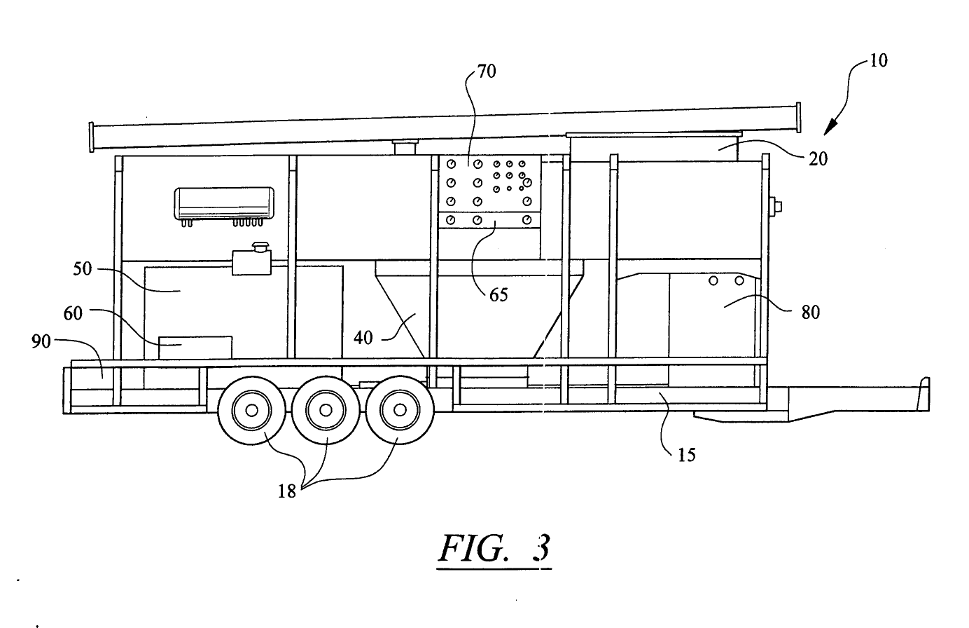

Like reference numerals refer to like parts throughout the several views of the drawings.

### DETAILED DESCRIPTION OF THE PREFERRED EMBODIMENTS

Referring to the several views of the drawings, the lightweight concrete manufacturing apparatus of the present invention is shown and is generally indicated as 10. As seen, the apparatus 10 is preferably supported on a trailer or chassis frame structure 15 with multiple axles and wheels 18 to support the weight of the apparatus. In this preferred embodiment, the apparatus 10 is intended to be towed by a vehicle, such as a truck.

The apparatus 10 includes a mixer 20 which is open on the top for receiving a loose flowing supply of concrete from a mixer truck or other on-site concrete manufacturing source. One or more tanks 30 are provided for containing chemical agents. In a preferred embodiment, the tanks hold one or more foaming agents (in liquid form) used in the manufacture of lightweight concrete. A hydraulically operated air compressor delivers pressurized air to a foam generating carburetor 65. The foaming agents, water and pressurized air are forced through the carburetor 65 to produce a foam product. In a preferred embodiment, the foaming agent is a concentrate known commercially as CONCRECEL™. Portland cement and the foam product are combined in mixer 20 in accordance with a predetermined mixture ratio. The cement and foam product are mixed and released into a concrete pump 40 under a controlled release process to insure a uniform and consistent mixture. An internal combustion engine 50 drives operation of hydraulic motors which, in turn, drive the components of the apparatus including the concrete pump. As the mixture is forcibly discharged from the concrete pump 40, pressurized air from the compressor 60 may be injected in the mixture to promote expansion. The concrete pump is screw driven by a hydraulic motor and, in a preferred embodiment, is a rotor stator pump.

A control panel 70 is provided with controls and gauges for operating, regulating and monitoring the several components throughout the mixture and discharge process, including a hydraulic system. The hydraulic system used for controlling the operation of most of the components includes a hydraulic oil tank 80 for containing the hydraulic fluid of the system and a transmission for delivering hydraulic fluid to the motors which drive the mixer, concrete pump, air compressor and other components. A fuel tank 90 holds a supply of fuel for operating the combustion engine.

While the instant invention has been generally shown and described in accordance with a preferred and practical embodiment thereof, it is recognized that departures from the instant disclosure are contemplated within the spirt and scope of the present invention.

1. An apparatus for making a lightweight concrete composition, comprising:
at least one tank for holding a foam concentrate;
a foam generating carburetor structured to receive the foam concentrate and a supply of water to produce a free flowing foam material;
a mixer for receiving the foam material and a supply of cement, and said mixer being structured and disposed for mixing the foam material and cement to produce a lightweight concrete mixture;
an air compressor for generating a pressurized supply of air for introduction into the lightweight concrete mixture to promote expansion of the lightweight concrete mixture; and
a pump for receiving the lightweight concrete mixture, and said pump being structured and disposed to forcibly discharge the lightweight concrete mixture from the apparatus for transfer and delivery to an installation site.

2. The apparatus as recited in claim 1 wherein said air compressor is driven by a hydraulic motor.

3. The apparatus as recited in claim 1 wherein said mixer is driven by a hydraulic motor.

4. The apparatus as recited in claim 1 wherein said pump is driven by a hydraulic motor.

5. An apparatus for making a lightweight concrete composition, comprising:
at least one tank for holding a foam generating agent;
an air compressor for generating a pressurized supply of air for introduction with the foam generating agent to produce a foam material;
a mixer for receiving the foam material and a supply of cement, and said mixer being structured and disposed for mixing the foam material and cement to produce a lightweight concrete mixture; and
a pump for receiving the lightweight concrete mixture, and said pump being structured and disposed to forcibly discharge the lightweight concrete mixture from the apparatus for transfer and delivery to an installation site.

6. The apparatus as recited in claim 5 further comprising:
a chassis frame structure with at least two opposite wheels on an axle for supporting the apparatus and transporting the apparatus behind a towing vehicle.

7. An apparatus for making a lightweight concrete composition, comprising:
at least one tank for holding a foam generating agent;
a foam generating carburetor structured to receive the foam generating agent and a supply of water to produce a free flowing foam material;
a mixer for receiving the foam material and a supply of cement, and said mixer being structured and disposed for mixing the foam material and cement to produce a lightweight concrete mixture; and
a pump for receiving the lightweight concrete mixture, and said pump being structured and disposed to forcibly discharge the lightweight concrete mixture from the apparatus for transfer and delivery to an installation site.

8. The apparatus as recited in claim 7 further comprising:
a chassis frame structure with at least two opposite wheels on an axle for supporting the apparatus and transporting the apparatus behind a towing vehicle.
